(19) United States
(12) Patent Application Publication
(10) Pub. No.: US 2006/0242143 A1
(43) Pub. Date: Oct. 26, 2006

(54) System for processing medical image representative data from multiple clinical imaging devices

(76) Inventors: Matthew Paul Esham, Pennsville, NJ (US); Melissa Richter, Morgantown, PA (US); Richard Poynton, Media, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/218,014

(22) Filed: Sep. 1, 2005

Related U.S. Application Data
(60) Provisional application No. 60/653,789, filed on Feb. 17, 2005.

(51) Int. Cl. G06F 17/30

(52) U.S. Cl. 707/6

(57) ABSTRACT

A multi imaging modality reading system enables medical report generation to begin earlier in a workflow process by enabling automatic image correlation of images derived by one or multiple, imaging modalities allowing for comparison of pathology over time and between modalities. A user interface system for accessing multiple medical images derived from different types of medical imaging systems includes at least one repository. The at least one repository associates, multiple different medical images derived from corresponding multiple different types of medical imaging systems, with data identifying a particular anatomical body part of a particular patient and with data identifying the different types of medical imaging systems. A display processor accesses the at least one repository and initiates generation of data representing a composite display image including multiple image windows individually including different medical images derived from corresponding multiple different types of medical imaging systems for a particular anatomical body part of a particular patient.

This is a non-provisional application of provisional application Ser. No. 60/653,789 by M. Esham filed Feb. 17, 2005.

### FIELD OF THE INVENTION

This invention concerns a user interface system for accessing multiple medical images derived from different types of medical imaging systems.

### BACKGROUND OF THE INVENTION

In existing medical imaging report generation systems, a user is typically required to formulate time-consuming reports following image data acquisition and to view multiple exams as separate imaging studies, therefore requiring the user to manually compile and integrate the information into a single knowledge-view. In existing systems report generation typically begins after image data acquisition, which is time consuming with multiple actors reproducing the same information. This may result in a clinician failing to see multiple small “anomalies” occurring in images derived from multiple corresponding different imaging modalities (such as MR, CT, X-ray, Ultrasound etc.) that individually may be missed by a clinician. Existing system also are inefficient in enabling a user to locate and display selected data. A system according to invention principles addresses these deficiencies and related problems.

### SUMMARY OF INVENTION

A multi imaging modality reading system allows a user to assign data items (e.g., tags) to images at acquisition supporting pre-population of a report template and user selection of a series of images for viewing as well as selection of a pre-configured image reading (viewing) template. A user interface system for accessing multiple medical images derived from different types of medical imaging systems includes at least one repository. The at least one repository associates, multiple different medical images derived from corresponding multiple different types of medical imaging systems, with data identifying a particular anatomical body part of a particular patient and with data identifying the different types of medical imaging systems. A display processor accesses the at least one repository and initiates generation of data representing a composite display image including multiple image windows individually including different medical images derived from corresponding multiple different types of medical imaging systems for a particular anatomical body part of a particular patient.

### BRIEF DESCRIPTION OF THE DRAWING

FIG. 1 shows a hospital information system including a multi modality image reading system, according to invention principles.

FIG. 2 illustrates a task sequence for processing image data and providing a composite multi-modality image reading template, according to invention principles.

FIG. 3 shows an image data and tag hierarchy used in accessing and configuring a display of images derived from different imaging modalities, according to invention principles.

FIG. 4 shows a flowchart of a process for pre-populating a medical report and for accessing medical images, according to invention principles.

FIGS. 5-17 illustrate a user interface and process for associating tags with medical images, according to invention principles.

### DETAILED DESCRIPTION OF THE INVENTION

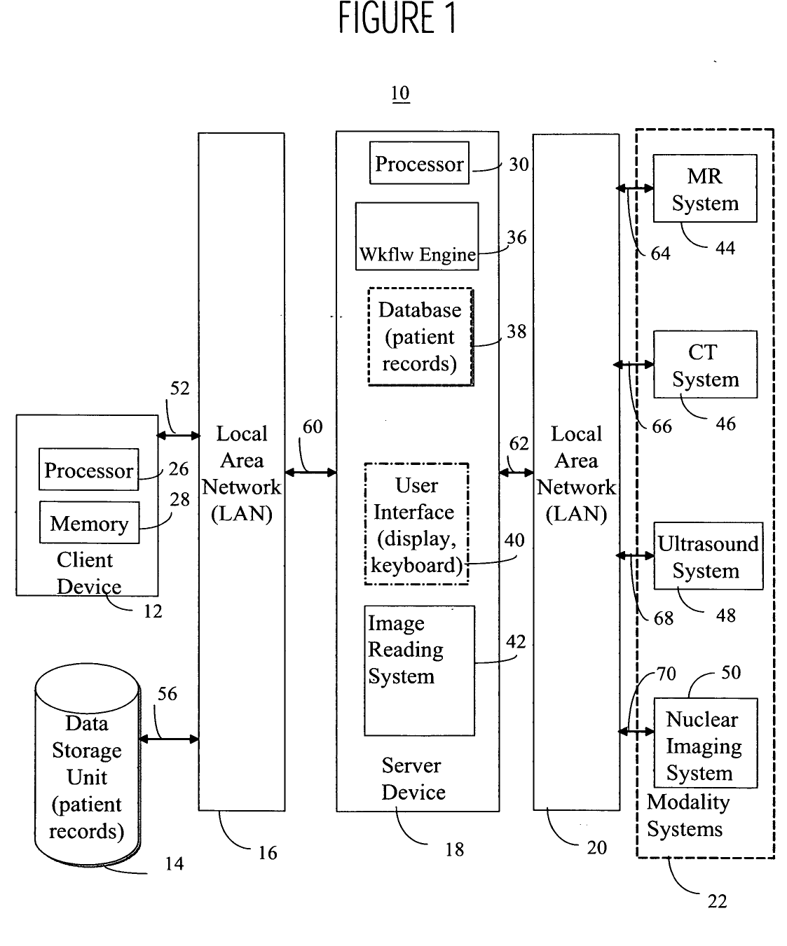

FIG. 1 shows a hospital information network 10 including a multi modality image reading system 42. The system incorporates a workflow engine 36 to support report generation earlier in a workflow cycle than in a typical existing image reading system. Image reading system 42 associates related images of a particular patient derived from multiple different modality imaging devices such as MR, CT, X-ray, Ultrasound, etc. Multi-modality image reading system 42 associates images derived from multiple different modality devices based on pathology and on anatomic layout in order to advantageously provide a user with an overall comprehensive clinical view of relevant patient medical image data. In a preferred embodiment image reading system 42 also generates a template (framework) of a report during image data acquisition rather than following image data acquisition. Image reading system 42 employs user interface system 40 including a configuration processor enabling a user to assign tags (e.g., values or identifiers) to images at the time of image acquisition or afterwards. Image reading system 42 uses the assigned tags to pre-populate a medical report template concerning a patient medical condition. The report template may be provided or processed by a reporting application. Image reading system 42 allows a user to select a series of medical images derived from one or more different imaging modalities and automatically correlates and identifies images for viewing based on assigned tag information as well as on a pre-configured image reading template.

Image reading system 42 advantageously enables automatic correlation of related images derived from one or different imaging modalities enabling both comparison of pathology shown in the images over time and comparison of pathology shown in images derived from different modalities. Image reading system 42 allows a user to input information comprising tags and associate the information with particular images during the acquisition of the images. A reporting function in system 42 compiles the images into a template medical report using the tags. This may be done while the tag information is being entered to advantageously support report generation earlier in a workflow cycle than in a typical existing image reading system. Alternatively, this may be done after the information has been entered by a user. In response to a physician entering data indicating a particular anatomical region of a patient, image reading system 42 identifies and displays related images concerning the patient anatomical region. System 42 identifies related images concerning the patient anatomical region that are derived from multiple different imaging modalities using image tags indicating they are associated with the patient anatomical region or indicating the images concern a common pathology.

The term pathology comprises an anatomical or functional manifestation of a disease or other patient medical condition. An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A display processor or generator is a known element comprising electronic circuitry or software or a combination of both for generating display images or portions thereof. A user interface comprises one or more display images enabling user interaction with a processor or other device. A tag as used herein may comprise an identifier, label, descriptor or other indicator. An image view tag may uniquely identify a particular image view, an anatomical feature tag may uniquely identify a particular anatomical feature and a pathology tag may uniquely identify a particular pathology.

The healthcare information system 10 of FIG. 1 includes a client device 12, a data storage unit 14, a first local area network (LAN) 16, a server device 18, a second local area network (LAN) 20, and imaging modality systems 22. The client device 12 includes processor 26 and memory unit 28 and may comprise a personal computer, for example. The healthcare information system 10 is used by a healthcare provider that is responsible for monitoring the health and/or welfare of people in its care. Examples of healthcare providers include, without limitation, a hospital, a nursing home, an assisted living care arrangement, a home health care arrangement, a hospice arrangement, a critical care arrangement, a health care clinic, a physical therapy clinic, a chiropractic clinic, and a dental office. Examples of the people being serviced by the healthcare provider include, without limitation, a patient, a resident, and a client.

Multi-imaging modality reading system 42 in server 18 operating in conjunction with user interface system 40 allows a user to assign tags to images at acquisition time supporting pre-population of a report template and user selection of a series of images for viewing as well as selection of a pre-configured image reading template. User interface system 40 displays a composite image (an image view) including medical images derived from multiple different imaging modalities that are identified by reading system 42 as being related to a particular patient anatomical region or a common pathology based on image associated tags. Server device 18 permits multiple users to employ reading system 42 using multiple different client devices such as device 12. In another embodiment user interface system 40 and system 42 are located in client device 12. User interface system 40 includes an input device that permits a user to provide input information to system 40 and an output device that provides a user a display of a composite image including medical images derived from multiple different imaging modalities and other information. Preferably, the input device is a keyboard and mouse, but also may be a touch screen or a microphone with a voice recognition program, for example. The output device is a display, but also may be a speaker, for example. The output device provides information to the user responsive to the input device receiving information from the user or responsive to other activity via user interface 40 or client device 12. For example, a display presents information responsive to the user entering information via a keyboard.

Server device 18 includes processor 30, Workflow Engine 36, database 38 including patient records and patient treatment plans, UI system 40 and image reading system 42. Server device 18 may be implemented as a personal computer or a workstation. Database 38 provides a location for storing medical images for multiple patients and associated patient records and data storage unit 14 provides an alternate store for patient records, as well as other information for hospital information system 10. The information in data storage unit 14 and database 38 is accessed by multiple users from multiple client devices. Alternatively, medical images and patient records may be accessed from memory unit 28 in client device 12. Patient records in data storage unit 14 include information related to a patient including, without limitation, biographical, financial, clinical (including medical images), workflow, care plan and patient encounter (visit) related information.

In operation patient medical images are being acquired at different imaging modality devices 22. In an example, images are acquired from three different modality devices 22 providing Heart Catheterization images from MR unit 44, Cardiac Ultrasound images from ultrasound unit 48 and Nuclear Cardiology images from nuclear imaging unit 50. The images are acquired by image reading system 42 in conjunction with workflow engine 36 via LAN 20 for display on user interface 40 (or client device 12). During an acquisition task sequence (workflow) performed by reading system 42 and workflow engine 36, an individual segment of image data viewed by a user is referred to as an image view. An image view has a specific section or sections of anatomy associated with it. Image reading system 42 enables a user to configure image view representative data and append images with tags according to an anatomical map and associated pathology. For example, a user configures a view called TTE Parasternal Long Axis. In the full Anatomy structure, there are the following anatomy structures associated with this view: Left Ventricle, Septum, Posterior Wall, Mitral Valve, Posterior Mitral Valve Leaflet, Anterior Mitral Valve Leaflet, Ascending Aorta, Right Coronary Cusp, Non Coronary Cusp, Sino tubular junction, etc. This amount of data exceeds the quantity that a user is able to reasonably concurrently examine and assess in a display. Consequently, reading system 42 enables a user to configure a composite display to include the particular views desired.

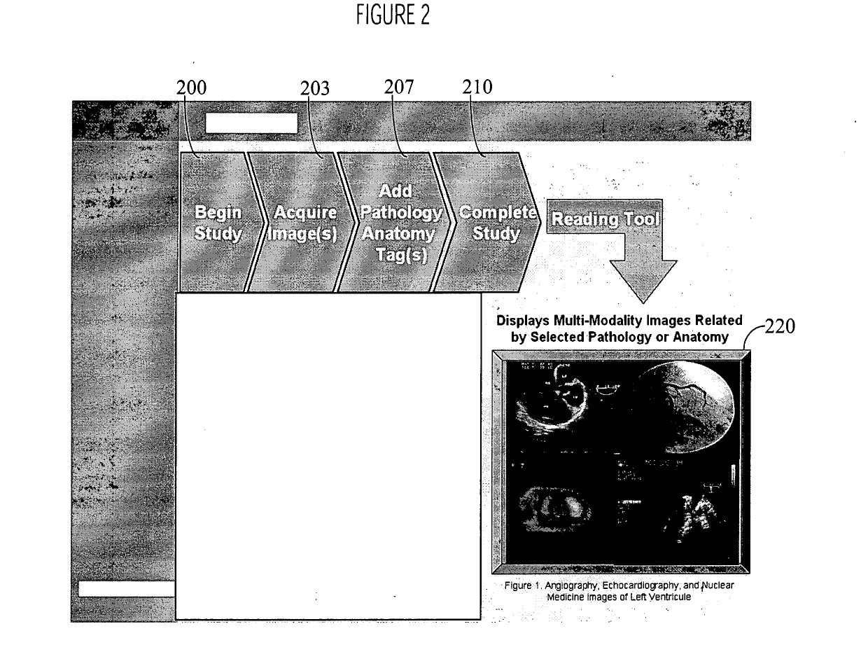

FIG. 2 illustrates a task sequence for processing image data involving providing a composite multi-modality image medical report template. The task sequence is implemented by image reading system 42 in conjunction with workflow engine 36 and user interface 40. In response to a user initiating an image study in step 200, reading system 42 acquires images in step 203 and adds anatomical and pathology tags to the acquired images in step 207 and completes the study in step 210. Individual images may be tagged during or after the acquisition procedure. The steps may be performed by image reading system 42 based on predetermined instruction and configuration information. In another embodiment, the steps are performed in response to user command. Reading system 42 provides a medical report template incorporating images acquired and tagged in steps 203 and 207 derived from multiple different imaging modalities. The report template is populated with the images in response to predetermined report template configuration information using the allocated tags. Similarly, image reading system 42 initiates creation of image view 220 based on an image reading template populated with the images in response to predetermined reading template configuration information using the allocated tags. Specifically, image view 220 incorporates different modality images comprising angiography, echocardiography and nuclear medicine images of a heart left ventricle. Image reading system 42 advantageously increases physician efficiency by eliminating reproduction of redundant information and accelerating medical report generation. Reading system 42 also facilitates improved clinical evaluation of a patient medical condition by accumulating and consolidating, in a composite image view, multiple examination images derived from different modalities.

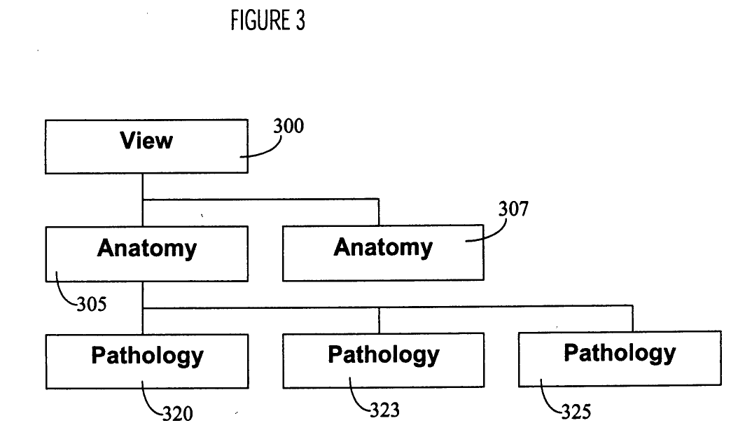

FIG. 3 shows an image data and tag (identifier) hierarchy used in accessing and configuring a display of images derived from different imaging modalities. The hierarchy enables a user to configure a particular image view with an image view tag 300 and associated particular anatomical features with corresponding anatomical feature tags 305 and 307 and associated pathologies with pathology identifier tags 320, 323 and 325 respectively. Image reading system 42 enables a user to associate a particular image view with candidate user selectable anatomical features and with candidate user selectable pathology options based on predetermined rules and predetermined information in a repository. The repository associates predetermined image views with corresponding candidate anatomical features and with multiple candidate pathology options.

User interface 40 provides configuration menus enabling a user to select one or more image views and image view tags, (e.g., tag 300), and associate the selected image view and tag 300 with user selectable corresponding candidate anatomical features and respective feature tags, (e.g., tag 305 and 307). Thereby a user may configure an image view of a particular patient (having a patient identifier) to have particular images derived from different imaging modalities 22 (FIG. 1) associated with corresponding different anatomical features. Similarly, the configuration menus enable a user to associate candidate anatomical features and respective feature tags, (e.g., tag 305 and 307) with user selected particular pathologies and respective pathology tags, (e.g., tags 320, 323 and 325). An image view to be presented on user interface 40 for a particular patient (and patient identifier) may thereby comprise images derived from different imaging modalities based on occurrence of particular pathologies.

The pathology and anatomy tags comprise data that is stored as a Private (or other) DICOM Element in data compatible with the DICOM image protocol, for example. Allocated tags assist in developing a framework of a medical report for an imaging study using a data map that correlates correct pathology statements into fields in the report template. Image reading system 42 maintains a log of tag information input by a clinician and allocates version identifiers to individual tags. The version identifiers enable reading system 42 to perform a statistical evaluation on allocated tags and determine whether or not they are updated and the frequency of such update. The statistical evaluation and resulting statistics enable reading system 42 to determine the accuracy of allocation of pathology and anatomy tags by clinicians to images being captured in order to facilitate continuous system improvement.

The tag hierarchy advantageously enables a user to configure an image view as a composite image comprising images derived from multiple different imaging modalities associated with different anatomical features and different pathologies for incorporation in a medical report template. Image reading system 42 dynamically creates a pre-configured image view for a particular patient to incorporate images derived from different imaging modalities. This may be done in response to occurrence of particular pathologies as identified from patient medical information associated with images from the different imaging modalities. A configured image view advantageously provides a user with information indicating a deeper level of understanding of a patient medical condition.

Image reading system 42 employs the tag hierarchy to enable a user to create an image reading template configured to incorporate a series of desired medical images for display in a desired sequence. A user is able to configure an anatomical image reading template to automatically identify and correlate images derived from different imaging modalities and different image studies associated with predetermined anatomical features. The different image studies may be automatically identified by image reading system 42 or may be selected by a user via user interface 40. A user is able to create or select an already created particular configured anatomical image reading template from multiple predetermined configured anatomical image reading templates. The template includes an image view for a particular patient incorporating images derived from image studies produced by different imaging modalities.

The image studies produced by the different imaging modalities include a heart catheterization study, an ultrasound study, and a Nuclear Multi-Gated Acquisition (MUGA) scan study, for example. Thereby a user is presented with an image of a first anatomical feature produced by a first imaging modality together with a corresponding image of a second anatomical feature (which may be the same as, or different from, the first anatomical feature) produced by a different second imaging modality. A user may also configure and select a pathology image reading template including an image view for a particular patient incorporating images derived from image studies produced by different imaging modalities and associated with different pathologies. A user may configure a pathology image reading template to include an image view for a particular patient incorporating images derived from image studies including a heart catheterization study, an ultrasound study, and a Nuclear study and having a pathology tag indicating LAD Stenosis, for example. The catheterization study shows an RAO Caudal view to display the LAD, the ultrasound study shows the 4ch and the nuclear scan shows the anterior wall, for example. Thereby, image reading system 42 automatically identifies and correlates images derived from different imaging modalities avoiding manual image correlation.

Image reading system 42 may be employed in both small and large healthcare systems. A small system may be used by an individual hospital department, or an imaging modality facility, for example. A large system may be used by multiple hospital departments, or multiple imaging modality facilities, for example. In such a large system, image reading system 42 employs a preconfigured tag hierarchy to correlate images derived from different imaging modalities based on anatomy or pathology and integrates information from the different modalities to provide a comprehensive view of an individual image study. Image reading system 42 is used to generate rapid, efficient medical reports during image acquisition, advantageously early in an imaging workflow cycle. This increases clinician efficiency by reducing entry operations and the time needed to create a medical report.

Continuing with the system of FIG. 1, a configuration and authorization function within processor 30 (FIG. 1) determines whether a user is authorized to access images of a particular patient and allocate tag information to the images. Patient record information in databases 14 and 38 may be stored in a variety of file formats and includes data indicating treatment orders, medications, images, clinician summaries, notes, investigations, correspondence, laboratory results, etc

The first local area network (LAN) 16 (FIG. 1) provides a communication network among the client device 12, the data storage unit 14 and the server device 18. The second local area network (LAN) 20 provides a communication network between the server device 18 and different imaging modality systems 22. The first LAN 16 and the second LAN 20 may be the same or different LANs, depending on the particular network configuration and the particular communication protocols implemented. Alternatively, one or both of the first LAN 16 and the second LAN 20 may be implemented as a wide area network (WAN). The communication paths 52, 56, 60, 62, 64, 66, 68 and 70 permit the various elements, shown in FIG. 1, to communicate with the first LAN 16 or the second LAN 20. Each of the communication paths 52, 56, 60, 62, 64, 66, 68 and 70 may be wired or wireless and adapted to use one or more data formats, otherwise called protocols, depending on the type and/or configuration of the various elements in the healthcare information systems 10. Examples of the information system data formats include, without limitation, an RS232 protocol, an Ethernet protocol, a Medical Interface Bus (MIB) compatible protocol, DICOM protocol, an Internet Protocol (I.P.) data format, a local area network (LAN) protocol, a wide area network (WAN) protocol, an IEEE bus compatible protocol, and a Health Level Seven (HL7) protocol.

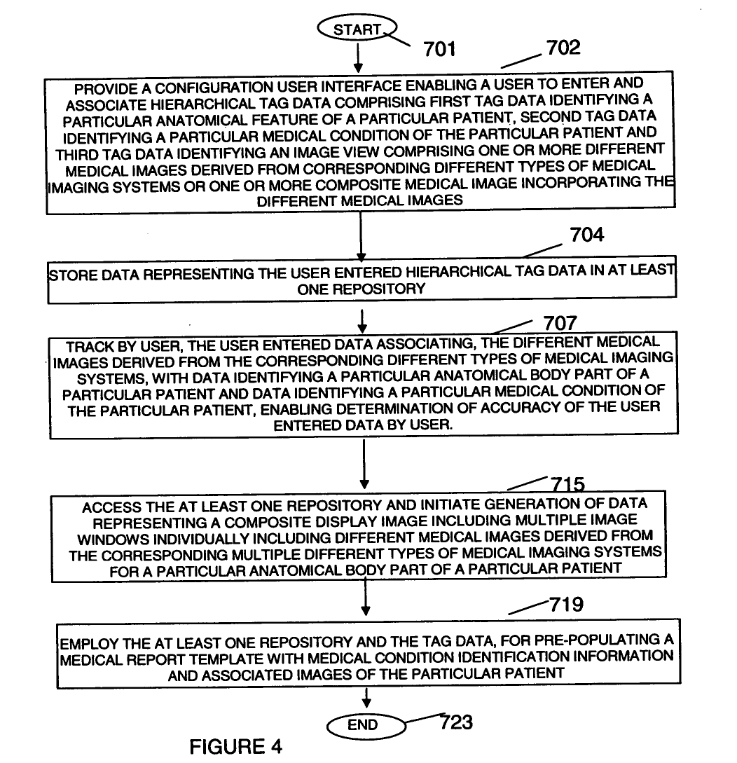

FIG. 4 shows a flowchart of a process performed by image reading system 42 in conjunction with workflow engine 36 and unit 40, for pre-populating a medical report and for accessing medical images. A configuration processor in user interface 40 (FIG. 1) in step 702, following the start at step 701, enables a user to enter and associate hierarchical (or non-hierarchical) tag data identifiers both with each other and with selected images of the multiple medical images. The tag data includes first tag data identifying a particular anatomical feature (e.g., body part) of a particular patient, second tag data identifying a particular medical condition of the particular patient and third tag data identifying (and predetermining) an image view comprising one or more medical images derived from the corresponding different types of medical imaging systems or one or more composite medical images incorporating the different medical images. User interface 40 also enables a user to enter data predetermining a user selectable or default sequence of composite display images to be presented to a user. Further, the tag data (identifiers) may be conveyed in DICOM compatible data fields such as a Private DICOM data field.

In step 704 image reading system 42 stores data representing the user entered hierarchical tag data in at least one repository (e.g., repositories 14, 28 and 38 of FIG. 1). The hierarchical tag data stored in the at least one repository associates, different medical images derived from corresponding different types of medical imaging systems, with data identifying a particular anatomical feature and a particular medical condition of a particular patient and with data identifying the different types of medical imaging systems. The at least one repository associates multiple different medical images with data identifying corresponding multiple different anatomical features of the particular patient. The at least one repository includes a data map linking at least one section of a medical report with tag data (e.g., first and second tag data), enabling pre-population of the medical report with medical condition identification information and associated images.

In step 707 image reading system 42 tracks by user, the user entered hierarchical tag data enabling determination of accuracy of the user entered hierarchical tag data by user. In step 715 image reading system 42 accesses the at least one repository and initiates generation of data representing a composite display image including multiple image windows individually including different medical images derived from corresponding multiple different types of medical imaging systems for a particular anatomical body part of a particular patient. Image reading system 42 accesses the at least one repository to identify data representing different medical images derived from a corresponding plurality of different types of medical imaging systems in response to user entered data identifying at least one of, (a) data identifying a particular anatomical body part of a particular patient and (b) data identifying a particular medical condition of the particular patient. Image reading system 42, in step 719, uses the at least one repository and the tag data, for pre-populating a medical report template with medical condition identification information and associated images of a particular patient. The process of FIG. 4 terminates at step 723.

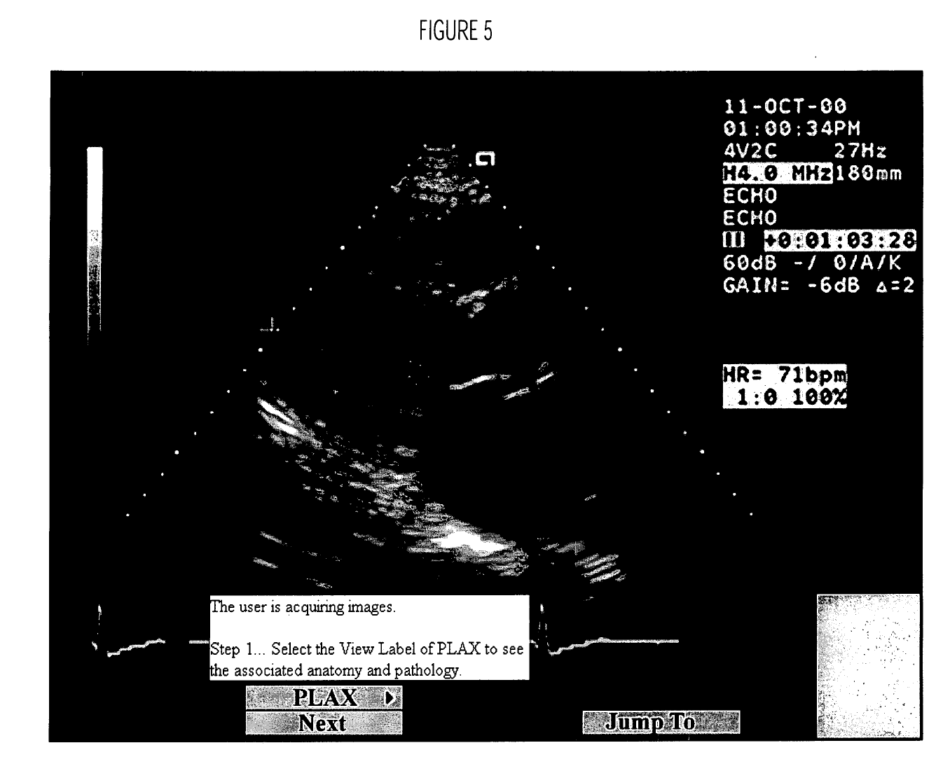

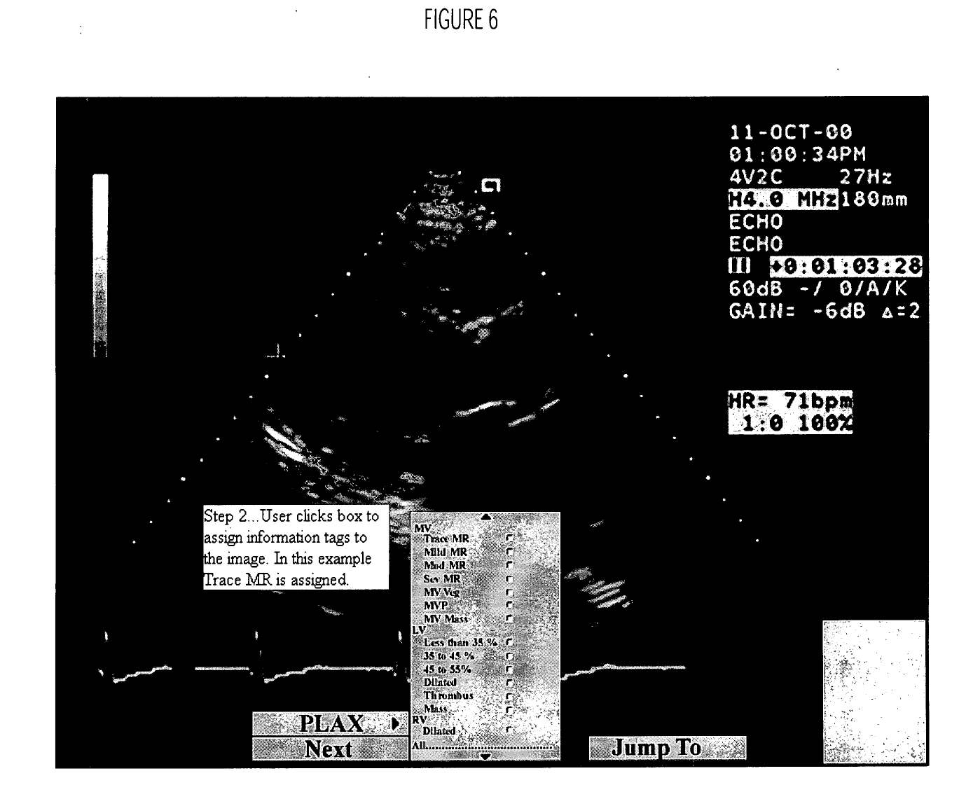

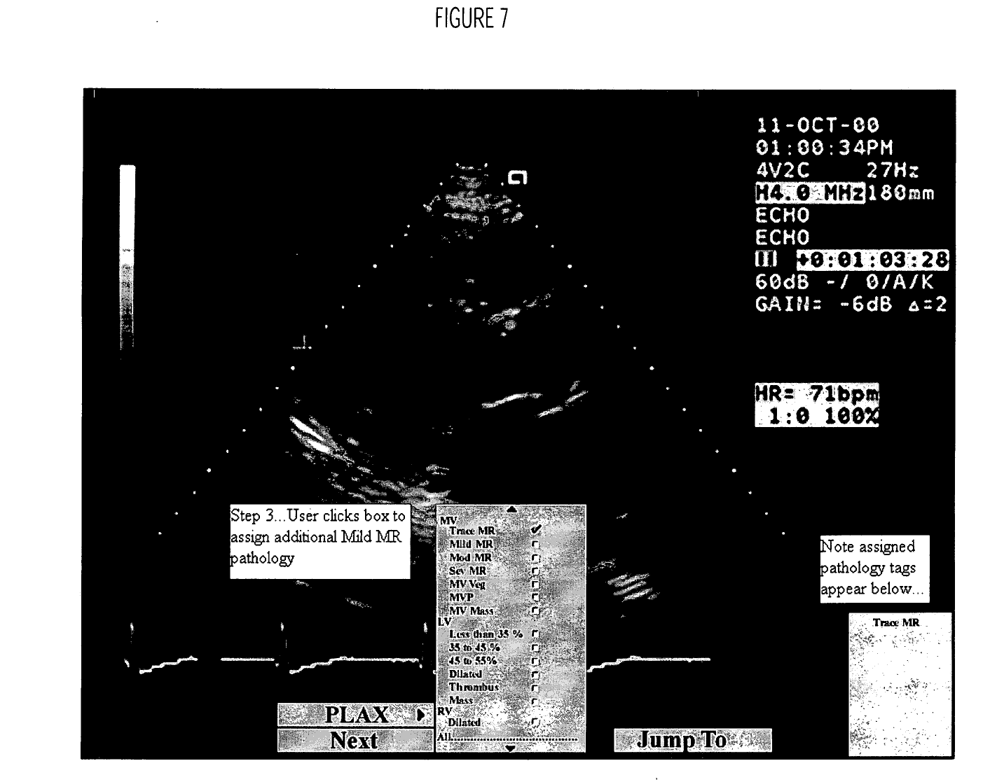

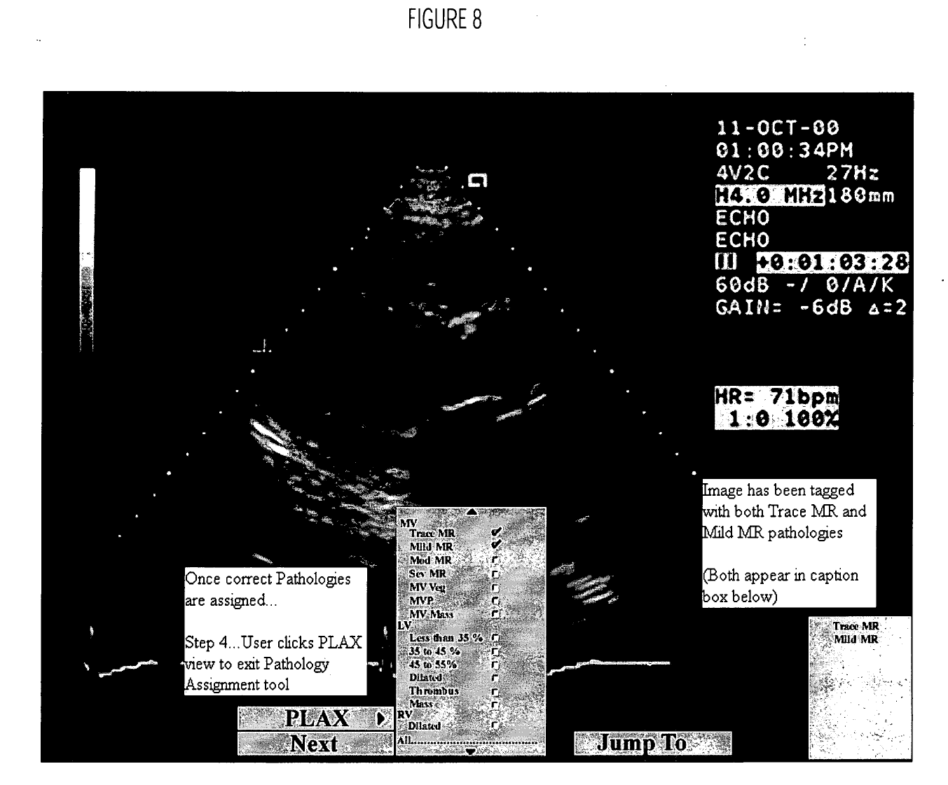

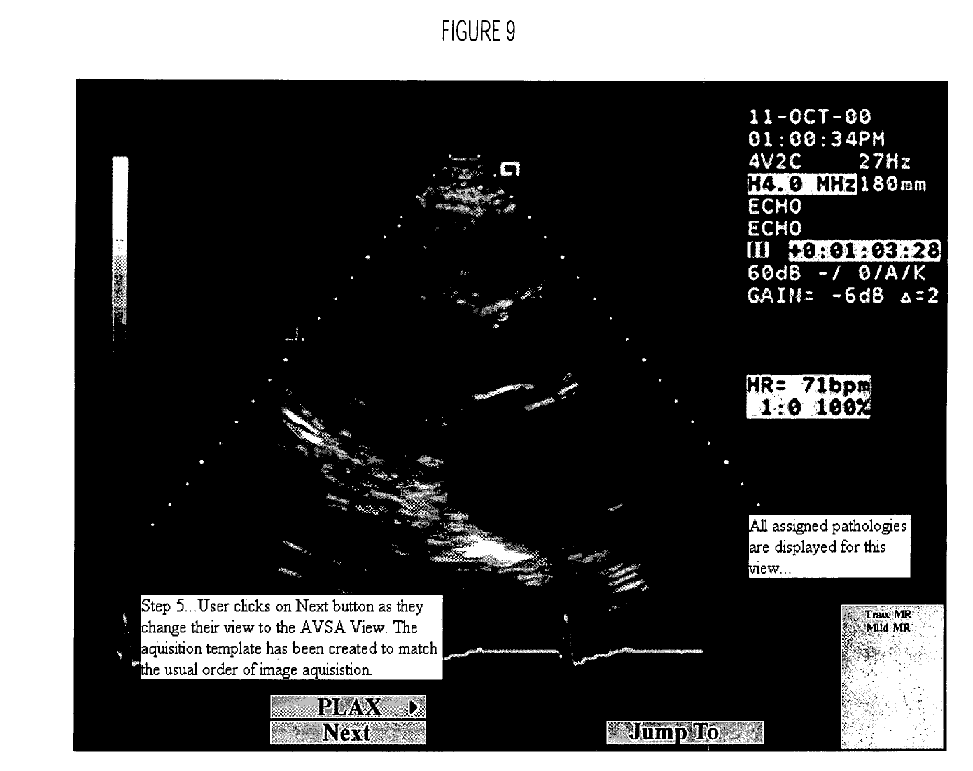

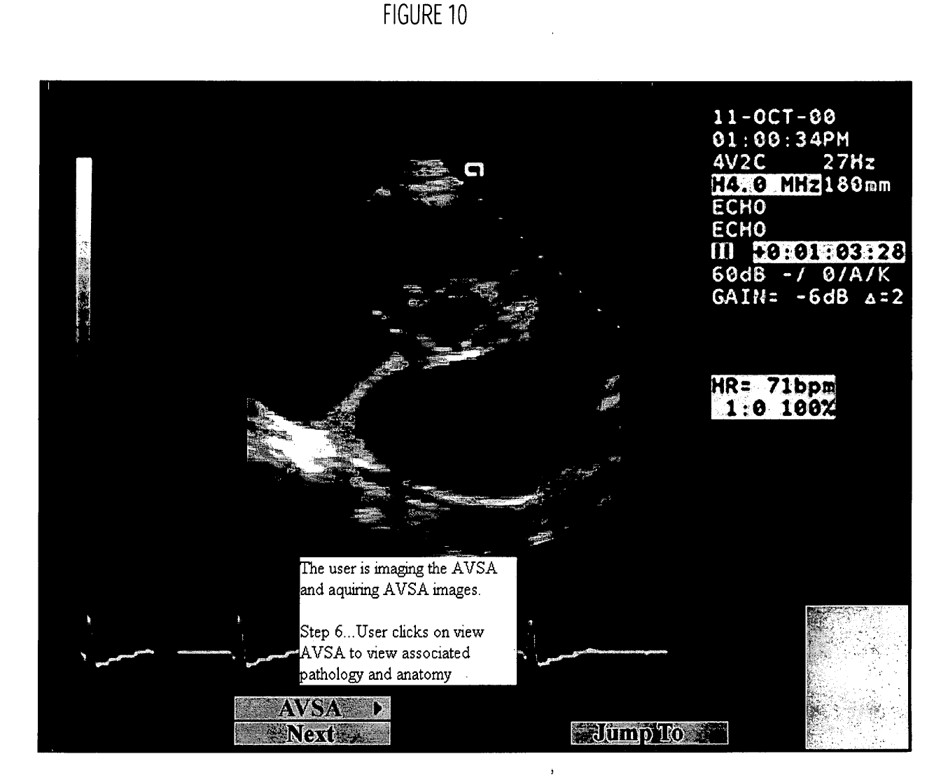

FIGS. 5-17 illustrate user navigable ultrasound display images and a process for associating tags with medical images provided by user interface 40 in conjunction with image reading system 42. In step 1 in FIG. 5 a user selects view label PLAX (parastemal long-axis) to see anatomical feature and pathology tags associated with a displayed ultrasound image of a patient. In response to the selection, the display image of FIG. 6 presents a menu incorporating user selectable anatomical feature and pathology tags associated with the displayed ultrasound image of a patient. User selection of Trace MR pathology in step 2 via the displayed menu of FIG. 6 is shown in FIG. 7 and in response to user selection of Mild MR box in step 3, additional Mild MR pathology is shown selected in FIG. 8. In response to selection of the view label PLAX in step 4, user interface 40 exits the pathology assignment menu and initiates presentation of the display image of FIG. 9 showing user selected tags (Trace MR and Mild MR) assigned to the displayed ultrasound image. Upon user selection of the Next button in the FIG. 9 image in step 5 the image display of FIG. 10 (providing an AVSA what is this? view image) is presented in FIG. 10. Image reading system 42 is used to configure an image reading template to present images in a sequence matching a usual order of image acquisition in this example.

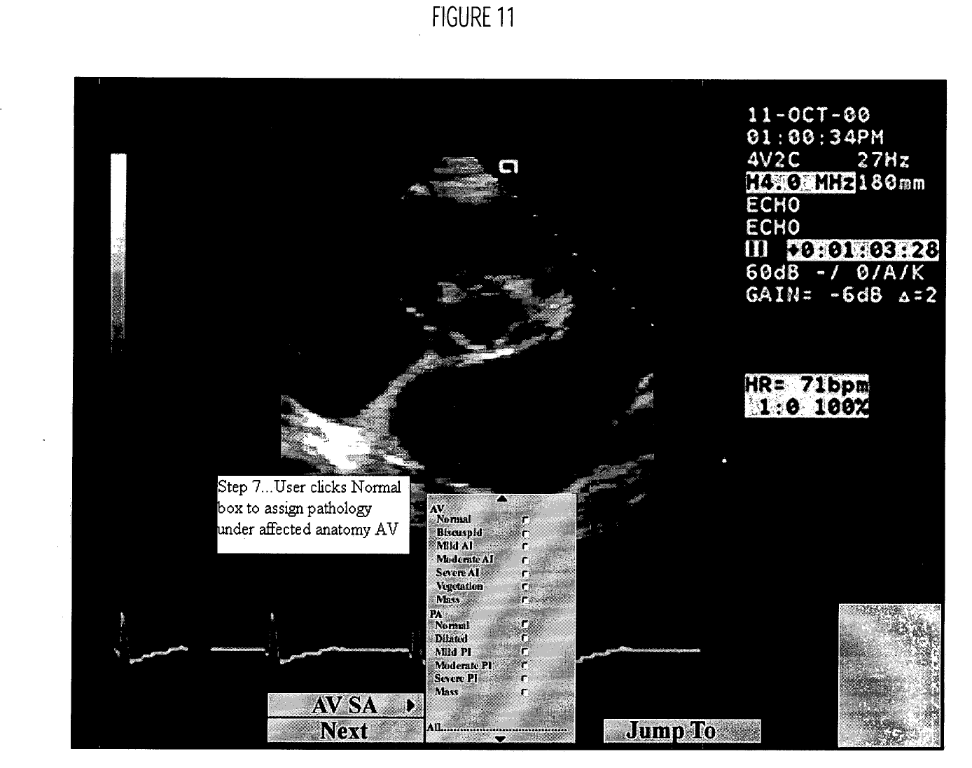

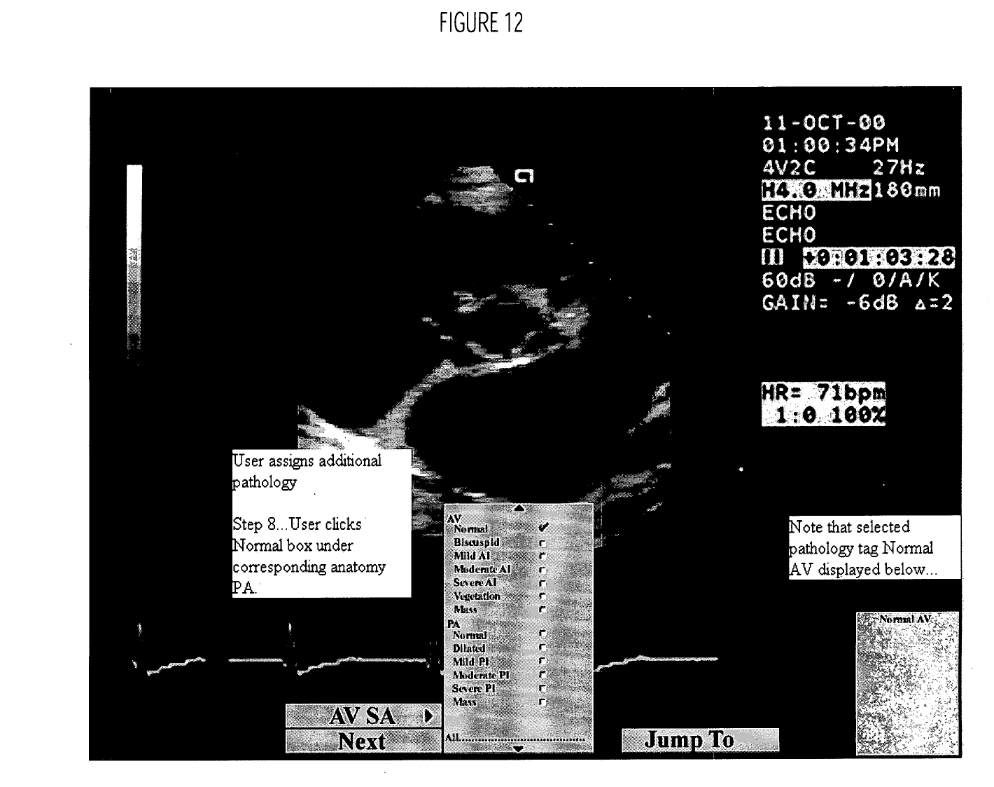

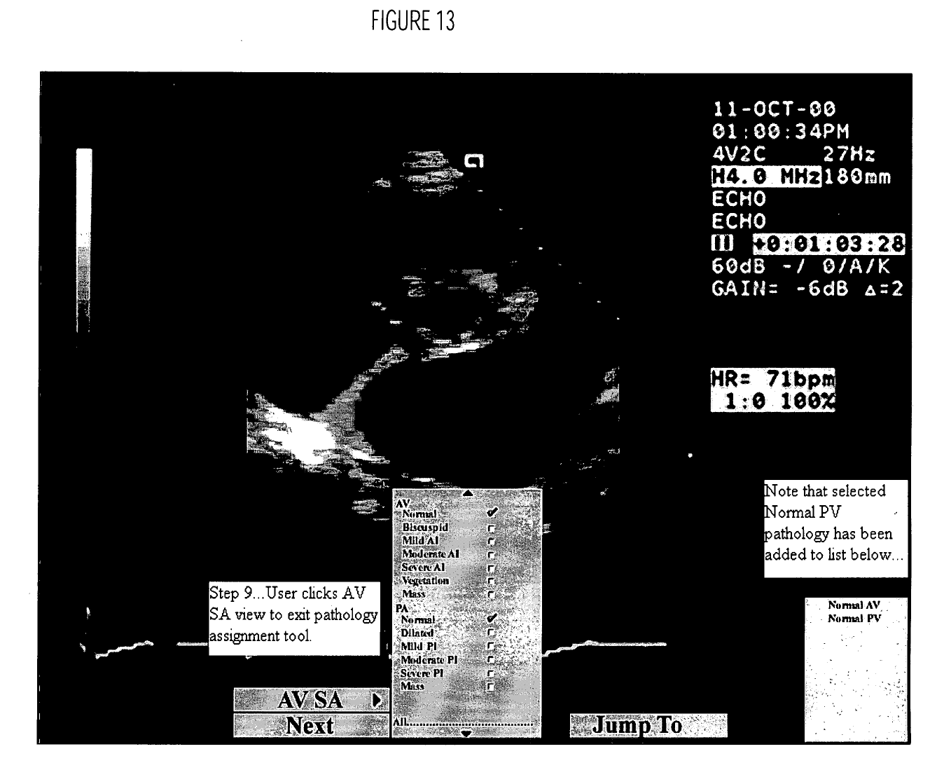

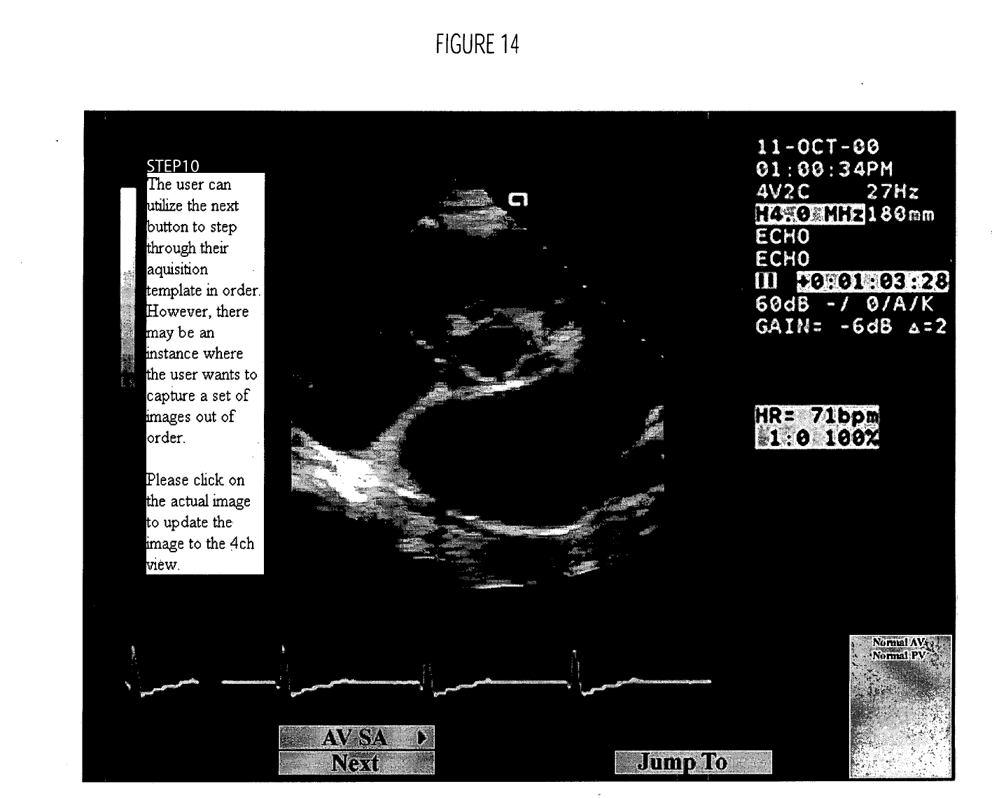

In step 6 in FIG. 10 a user selects view label AVSA to see pathology and associated anatomy tags of the displayed ultrasound AVSA image of a patient in a menu in FIG. 11. User assignment of Normal AV and Normal PV pathology tags to the ultrasound image is shown in FIG. 13 via pathology tag selection in steps 7 and 8 of FIGS. 11 and 12 respectively. In response to user selection of the view label AVSA in FIG. 13 in step 9, user interface 40 exits the pathology assignment menu and initiates presentation of the display image of FIG. 14 in step 10 showing user selected tags (Normal AV and Normal PV) assigned to the displayed ultrasound image. A user is able to page through a created image reading template in predetermined order using the Next button. However a user may also create a reading template to present images in a different sequence.

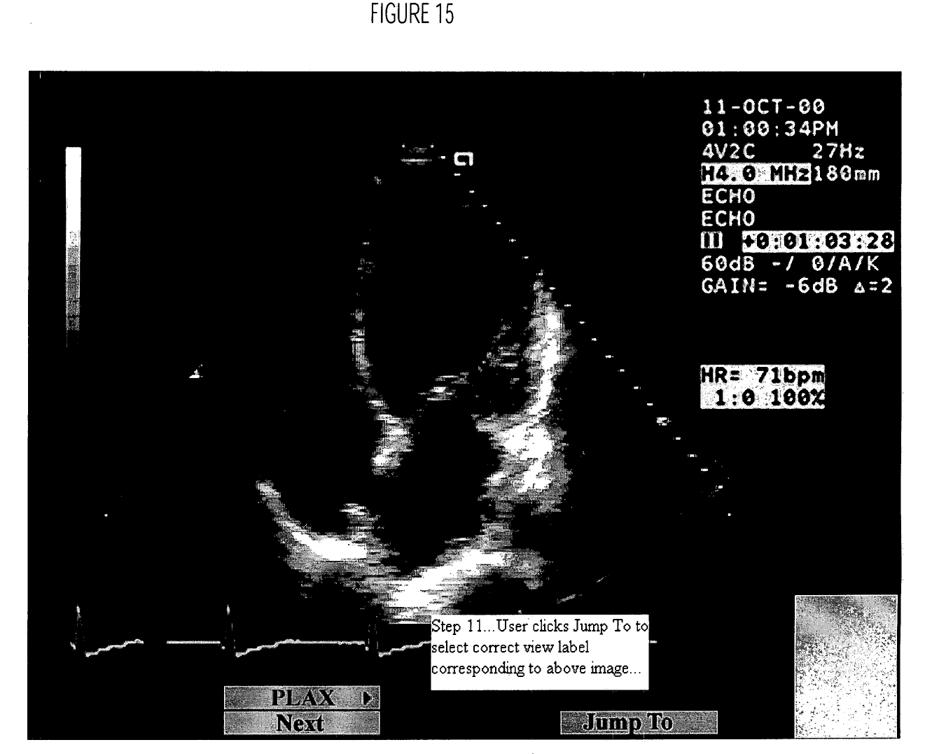

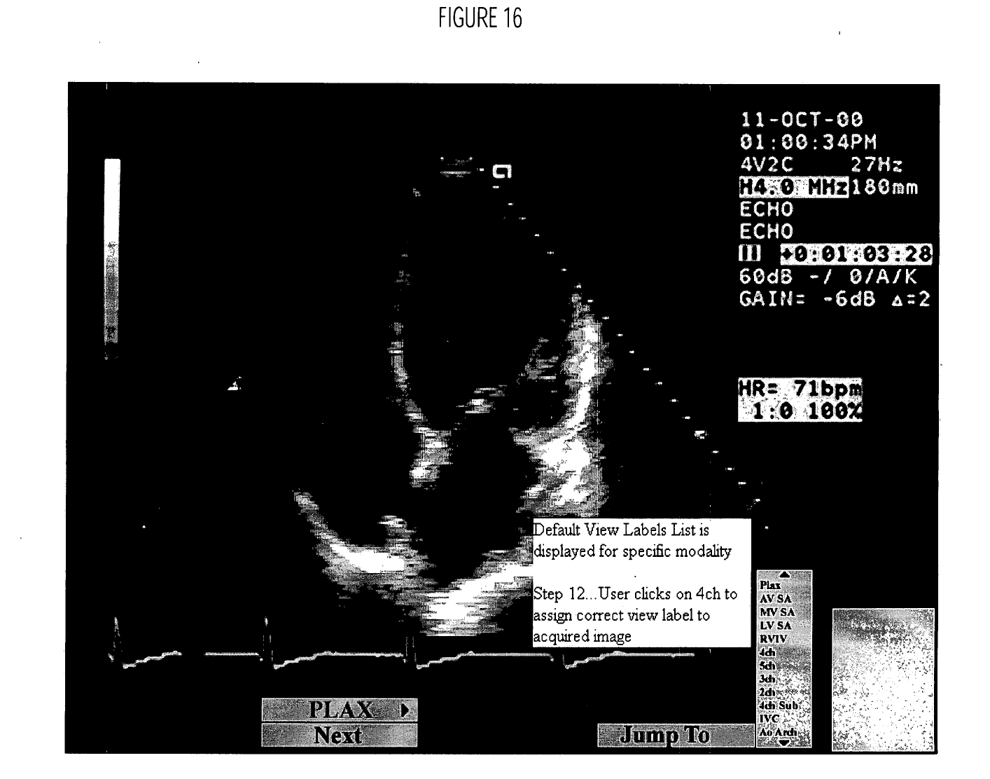

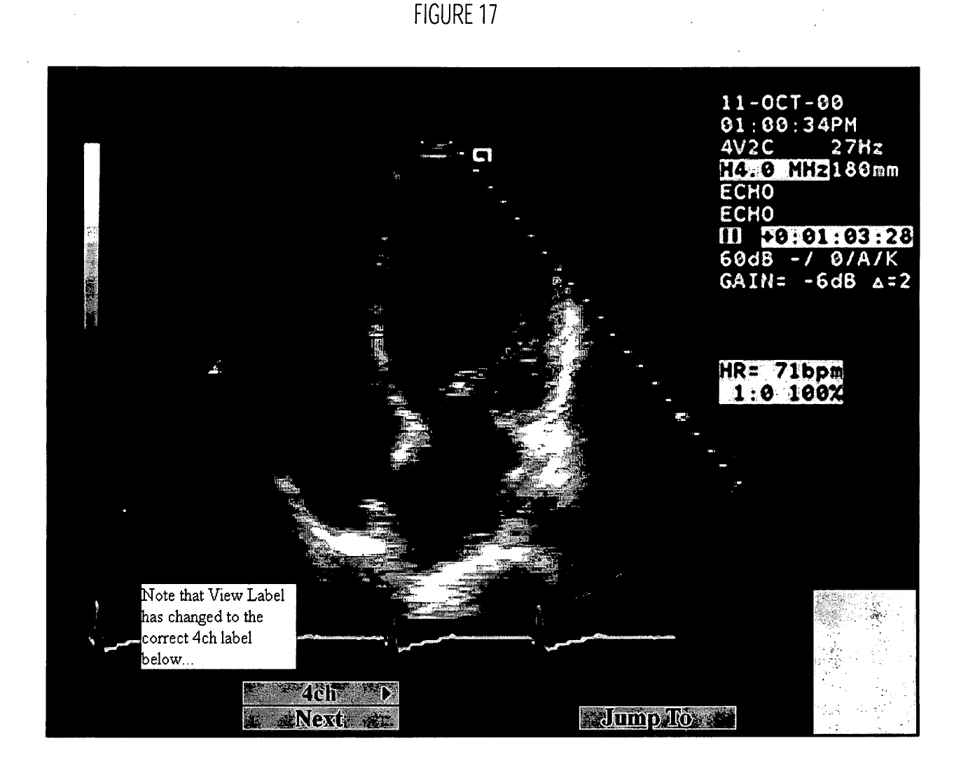

A user selects the displayed image in FIG. 14 to initiate presentation of the image of FIG. 15 (a 4ch view). Further, in response to user selection of the Jump To button in FIG. 15 in step 11, a menu is provided as shown in the image of FIG. 16 enabling user selection of a correct view label. The correct view label (4ch) is selected in step 12 and assigned to the image as shown in FIG. 17.

Image reading system 42 may be used IN multiple Clinical Environments including IN virtually any imaging modality acquisition system. The system, process and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and processes of FIGS. 1, 2 and 4, may be implemented in hardware, software or a combination of both.

What is claimed is:

1. A user interface system for accessing a plurality of medical images derived from different types of medical imaging systems, comprising:
at least one repository for associating, a plurality of different medical images derived from a corresponding plurality of different types of medical imaging systems, with data identifying a particular anatomical feature of a particular patient and with data identifying said different types of medical imaging systems; and
a display processor for accessing said at least one repository and for initiating generation of data representing a composite display image including a plurality of image windows individually including different medical images derived from a corresponding plurality of different types of medical imaging systems for a particular anatomical body part of a particular patient.

2. A system according to claim 1, wherein
said at least one repository associates said plurality of different medical images with data identifying a particular medical condition of said particular patient.

3. A system according to claim 2, including
a data map linking a plurality of different sections of a report with a plurality of different medical conditions identified in said at least one repository and enabling pre-population of a report with medical condition identification information and associated images.

4. A system according to claim 2, wherein
said display processor accesses said at least one repository to identify data representing different medical images derived from a corresponding plurality of different types of medical imaging systems in response to user entered data identifying at least one of, (a) data identifying a particular anatomical body part of a particular patient and (b) data identifying a particular medical condition of said particular patient.

5. A system according to claim 1, wherein
identifiers identifying association of said plurality of different medical images derived from said corresponding plurality of different types of medical imaging systems with at least one of, (a) data identifying a particular anatomical body part of a particular patient and (b) data identifying a particular medical condition of said particular patient, are conveyed in a DICOM compatible data field.

6. A system according to claim 1, including
a configuration processor enabling a user to predetermine images from user selected different types of medical imaging systems are to be presented in said composite display image.

7. A system according to claim 1, including
a configuration processor enabling a user to predetermine a plurality of composite display images individually including images from user selected different types of medical imaging systems, are to be presented in a sequence of composite display images.

8. A system according to claim 1, wherein
said configuration processor enables a user to predetermine said sequence of composite display images.

9. A system according to claim 1, including
a command processor enabling a user to enter data associating, said plurality of different medical images derived from said corresponding plurality of different types of medical imaging systems, with data identifying a particular anatomical body part of said particular patient.

10. A system according to claim 1, including
a command processor enabling a user to enter data associating, said plurality of different medical images derived from said corresponding plurality of different types of medical imaging systems, with data identifying a particular medical condition of said particular patient.

11. A system according to claim 9, wherein
said command processor tracks by user, said user entered data associating, said plurality of different medical images derived from said corresponding plurality of different types of medical imaging systems, with data identifying a particular anatomical body part of a particular patient and data identifying a particular medical condition of said particular patient, enabling determination of accuracy of said user entered data by user.

12. A system according to claim 1, wherein
said at least one repository associates said plurality of different medical images with data identifying a corresponding plurality of different anatomical features of said particular patient.

13. A user interface system for accessing a plurality of medical images derived from different types of medical imaging systems, comprising:
at least one repository for associating, a plurality of different medical images derived from a corresponding plurality of different types of medical imaging systems with,
first tag data identifying a particular anatomical feature of a particular patient and
second tag data identifying a particular medical condition of said particular patient; and
a display processor for accessing said at least one repository and for initiating generation of data representing a composite display image including a plurality of image windows individually including different medical images derived from a corresponding plurality of different types of medical imaging systems for a particular anatomical body part of a particular patient.

14. A system according to claim 13, wherein
said first and second tag data are hierarchically organized.

15. A system according to claim 13, wherein
said at least one repository associates said plurality of different medical images with third tag data identifying an image view comprising a composite medical image incorporating said plurality of different medical images derived from said corresponding plurality of different types of medical imaging systems.

16. A system according to claim 13, including
a configuration processor enabling a user to enter information comprising said first and second tag data.

17. A system according to claim 13, wherein
said at least one repository associates said plurality of different medical images with data identifying a corresponding plurality of different anatomical features of said particular patient.

18. A user interface system for accessing a plurality of medical images derived from different types of medical imaging systems, comprising:
at least one repository for associating, a plurality of different medical images of a particular patient derived from a corresponding plurality of different types of medical imaging systems with,
first tag data identifying a particular anatomical feature of a particular patient,
second tag data identifying a particular medical condition of said particular patient and
a data map linking at least one section of a medical report with at least one of, said first and second tag data, enabling pre-population of said medical report with medical condition identification information and associated images; and
a report processor for using said at least one repository and said first and second tag data, for pre-populating a medical report template with medical condition identification information and associated images of said particular patient.

19. A system according to claim 18, wherein
said at least one repository associates said plurality of different medical images with third tag data identifying an image view comprising a composite medical image incorporating said plurality of different medical images derived from said corresponding plurality of different types of medical imaging systems.

20. A system according to claim 19, including
a display processor for accessing said at least one repository and for initiating generation of data representing said image view.
